(19) United States
(12) Patent Application Publication
(10) Pub. No.: US 2025/0307743 A1
(43) Pub. Date: Oct. 2, 2025

(54) SYSTEMS AND METHODS FOR ASSESSING OPERATIONS, RISK-ADJUSTED OPERATIONAL EFFICIENCY, RISK-ADJUSTED OPERATING EFFECTIVENESS, AND RISK-ADJUSTED OPERATING LEVERAGE OF BANKS AND NON-BANKING FINANCE COMPANIES

(71) Applicant: Kannan Subramanian Ramakrishnan, Chennai (IN)

(72) Inventor: Kannan Subramanian Ramakrishnan, Chennai (IN)

(21) Appl. No.: 18/620,800

(22) Filed: Mar. 28, 2024

(51) Int. Cl. G06Q 10/0633; G06Q 10/0635

(52) U.S. Cl. CPC G06Q 10/0633; G06Q 10/0635

(57) ABSTRACT

Methods for determining risk-adjusted metrics are presented including a risk-adjusted process efficiency score, a risk adjusted process-based, enterprise-operating-model efficiency score, a risk-and-resource-utilization-adjusted, process-based enterprise-operating-model efficiency score, a risk-and-resource-utilization-adjusted, process-based enterprise-operating-model effectiveness score, and a risk-adjusted operating leverage. In addition, a method for assessing non-interest costs of a bank or non-banking finance company utilizing time-driven costs of resources for performance of the processes of the bank or non-banking finance company is presented.

### FIELD

The present invention is directed to the area of banks and non-banking finance companies. The present invention is also directed to methods and systems for assessing risk adjusted operational efficiency, risk-adjusted operating effectiveness, and risk adjusted operating leverage of banks and non-banking finance companies.

### BACKGROUND

Banks and non-banking finance companies typically measure their cost efficiency by dividing their (non-interest expenses) by their (net interest income+non-interest income) for a given period. The non-interest expense is also referred to as operating cost. This cost-to-income ratio, which can also be referred to as an efficiency ratio or cost efficiency ratio, provides only limited information about the bank or other money lending institution. For example, it does not provide information, or only provides limited information, on structural efficiency, fixed and variable cost base, operational risk exposure, non-interest cost management methodology, operational resilience, or how to improve sustainable profitability.

### BRIEF SUMMARY

One embodiment is a method for assessing non-interest costs of a bank or non-banking finance company. The method includes, for at least one process of a bank or non-banking finance company: identifying a plurality of activities of the process; for each of the activities or group of activities, determining at least one staff, at least one system, at least one non-staff, non-system resource or any combination thereof that is used to perform the activity or group of activities; for each of the activities or group of activities, determining a cost of performance of the activity or group of activities using the determined at least one staff, at least one system, at least one non-staff, non-system resource, or combination thereof that is used to perform the activity or group of activities; determining a cost of performance of the process using the determined costs of performance of the activities and groups of activities; and, for a predefined time period in which the process is performed N times, determining a cost of the performance of the process over the predefined time period by multiplying the cost of performance by N.

In at least some embodiments, the method further includes, for at least one of the at least one process of the bank or non-banking finance company, determining a resource utilization rate for the process by dividing the cost of the performance of the process over the predefined time period by a budgeted or allocated cost for the process over the predefined time period as determined using a cost allocation methodology that fully allocates costs to lines of business. In at least some embodiments, the method further includes, for at least one of the at least one process of the bank or non-banking finance company, determining a resource utilization rate for the process by dividing, the time-driven cost of the resources utilized for the performance of the process over the predefined time period, by, the actual cost incurred for the process over the predefined time period.

In at least some embodiments, determining the cost of performance of the activity includes, for each of the at least one staff, at least one system, and at least one non-staff, non-system resource used to perform the activity, obtaining a cost per time unit. In at least some embodiments, the method further includes, for each of the activities, obtain a number of time units for performance of the activity in a single performance of the process. In at least some embodiments, determining the cost of performance of the activity includes determining the cost of performing the activity by summing the costs per time unit of each of the at least one staff, at least one system, or at least one non-staff, non-system resource used to perform the activity and multiplying the sum by the number of time units used. In at least some embodiments, determining the cost of performance of the activity includes determining the cost of performing the activity by multiplying each of the costs per time unit of the at least one staff, at least one system, and at least one non-staff, non-system resource used to perform the activity by the number of time units used and summing results of all of the multiplications.

Another embodiment is a method for determining at least one risk-adjusted performance measure of operation or efficiency of a bank or non-banking finance company. The method includes, for each of a plurality of processes of the bank or non-banking finance company: determining, for the process, an assessment score for each of performance, risk management, and non-interest cost management; and determining a risk-adjusted process efficiency score as a composite of the assessment scores.

In at least some embodiments, the method further includes dividing operation of the bank or non-banking finance company into the plurality of processes of the bank or non-banking finance company. In at least some embodiments, the method further includes, for at least one of the processes of the bank or non-banking finance company, dividing the process into a plurality of activities.

In at least some embodiments, the method further includes identifying at least one of the processes of the financial information for efficiency improvement using the risk-adjusted process efficiency score for the processes of the financial information; identifying at least one action to improve the efficiency of the at least one of the processes of the bank or non-banking finance company; and perform at least one of the at least one action resulting in improvement of the efficiency of the at least one of the processes of the bank or non-banking finance company.

In at least some embodiments, the method further includes determining a risk-adjusted process-based enterprise-operating-model efficiency score as a composite of the risk-adjusted process efficiency scores of the each of the processes of the plurality of processes of the bank or non-banking finance company. In at least some embodiments, the method further includes determining a resource utilization rate; determining a shortfall score based on a difference between a target rate and the resource utilization rate; determining an adjusted resource utilization rate as a product of the resource utilization rate and the shortfall score; and determining a risk-and-resource-utilization-adjusted, process-based enterprise-operating-model efficiency score as a product of the risk-adjusted process-based enterprise-operating-model efficiency score and the adjusted resource utilization rate.

In at least some embodiments, the method further includes determining an achievement score for each of at least one goal of the bank or non-banking finance company; and determining a risk-and-resource-utilization-adjusted, process-based enterprise-operating-model effectiveness score as a product of the risk-and-resource-utilization-adjusted, process-based enterprise-operating-model efficiency score and the achievement score for each of the at least one goal. In at least some embodiments, the method further includes determining an operating leverage value as a percentage growth in revenue minus a percentage growth in operating cost; and determining a risk-adjusted operating leverage as a product of the risk-and-resource-utilization-adjusted, process-based enterprise-operating-model effectiveness score and the operating leverage value.

A further embodiment is a system that includes at least one memory having instructions stored thereon; and at least one processor configured to execute the instructions to perform actions, the actions including any of the methods described above.

Yet another embodiment is a non-transitory computer readable medium having instructions stored thereon, wherein the instructions, when executed by at least one processor, are configured to perform actions for determining at least one risk-adjusted measure of operation or efficiency of a bank or non-banking finance company, the actions including any of the methods described above.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a table of costs for a product allocated using a conventional non-interest cost allocation methodology;

FIG. 2 is a table of costs for the same product, as a summation of all its process costs, determined using time-driven activity-based non-interest costing methodology;

FIG. 3 is a flowchart of one embodiment of a method for assessing non-interest costs of a bank or non-banking finance company;

FIG. 4 is one embodiment of a chart dividing a business process into activities;

FIG. 5 is one embodiment of a chart identifying resources for each of the activities in FIG. 4 for determining a process-based cost of the activities;

FIG. 6 is a flowchart of one embodiment of a method for determining a resource utilization rate and, optionally, using the resource utilization rate for activity improvement;

FIG. 7 is a flowchart of one embodiment of a method for determining at least one risk-adjusted performance measure of operation or operational efficiency of a bank or non-banking finance company, a line of business, a support department, a product, or a support function of the bank or non-banking finance company;

FIG. 8 is a flowchart of one embodiment of a method for determining at least one risk-adjusted performance measure of operation or risk adjusted efficiency of a bank or non-banking finance company;

FIG. 9 is one embodiment of a chart for determining a risk-adjusted enterprise-operating-model efficiency, risk and resource utilization adjusted enterprise operating model efficiency, risk and resource utilization adjusted, enterprise operating model effectiveness, and risk adjusted operating leverage for a bank or non-banking finance company; and

FIG. 10 is one embodiment of a system for performing the methods described herein or portions of those methods.

### DETAILED DESCRIPTION

The present invention is directed to the area of banks and non-banking finance companies. The present invention is also directed to methods and systems for assessing risk adjusted operational efficiency, risk-adjusted operating effectiveness, and risk adjusted operating leverage of banks and non-banking finance companies.

The description herein is described using a bank as an example. The term “bank” includes other banking institutions, such as, for example, credit unions, saving and loan companies, or the like. It will also be understood that a non-banking finance company can be substituted for the bank in the description hereinbelow. In at least some embodiments, the methods and systems or portions thereof can be applicable to other financing entities.

Conventionally, a cost-to-income ratio is calculated as: (non-interest expenses)/(net interest income+non-interest income), which can be multiplied by 100 to give a percentage. The conventional cost-to-income ratio can also be referred to as a cost efficiency ratio. In at least some instances, this conventional efficiency ratio is an outdated approach towards measuring a bank's cost efficiency and has failed in the past to warn of operational difficulties, financial difficulties, or a possible failure of a bank. The conventional cost-to-income ratio provides only limited information about the bank. For example, the conventional cost-to-income ratio is not risk adjusted. As another example, the conventional cost-to-income ratio often does not provide information on structural efficiency or on how to improve profitability. The cost-to-income ratio does not consider resource utilisation, reveal the effectiveness of the enterprise operating model, or provide information about an enterprise non-interest cost management methodology or the cost of risk management.

The conventional cost-to-income ratio does not fully reflect operational resilience. Operational resilience refers to the ability of a bank or non-banking finance company to deliver critical operations through business disruption. In at least some embodiments, a bank assumes that disruptions will occur, and, in its operation, takes into account its overall risk appetite and tolerance for disruption. In at least some embodiments, the bank defines tolerance for disruption as a level of disruption from any type of operational risk that the bank is willing to accept.

As described herein, operational efficiency, and other determined metrics, can account for the operational aspect of risk and risk tolerance. Examples of types of risk that can be considered include, but are not limited to, one or more of (or all of) market risk, credit risk, liquidity risk, and operational risk. The types of risk may also include subcategories such as, for example, interest rate risk, price risk, re-pricing risk, option risk, yield curve risk, event risk, transaction risk, compliance risk, strategic risk, structural risk, reputation risk, or the like or any combination thereof. Examples of operational risks can include, but are not limited to, internal fraud, external fraud, faulty employment or business practices, worker safety, damage to physical assets, business disruption, system failure, employee or vendor error, client error, product delivery error, any other business-related error, or the like or any combination thereof.

Risk capacity represents the bank's ability to absorb potential losses. In at least some embodiments, the risk-taking financial strength of a bank can be revealed, at least partially, in the balance sheet of the bank. In at least some embodiments, risk tolerance represents the limit (which may be well defined or loosely defined) of the bank's risk acceptance. In at least some embodiments, risk tolerance is dictated, or influenced, by one or more policies defined by bank management or other decision maker(s) or any combination thereof. In at least some embodiments, risk appetite is the relative willingness by the bank to accept risk. Many banks publish a Risk Appetite Statement and the level of risk tolerance and risk appetite may be universally applied to all types of risk.

In at least some embodiments, risk capacity, risk tolerance, or risk appetite (or any combination thereof) are selected consistent with one or more goals, objectives, or financial strength of the bank. In at least some embodiments, risk capacity, risk tolerance, or risk appetite (or any combination thereof) account for known risks) . . . . The tangible cost of risk failure can include penalties, remedial costs, or the like. Risk management cost also includes the cost of monitoring. Intangible risk costs can include reputation loss, or the like.

As described herein, in at least some embodiments, a risk adjusted operating leverage can be determined using an assessment of performance, operational risks, controls and non-interest cost, and resource utilization. Banks and other financial interests often measure operating costs as non-interest costs. A Profit and Loss statement (or other listing) can provide a categorization of costs. Examples of categories include, but are not limited to, depreciation, insurance, employee, IT (Information Technology, which may include software, hardware, or any combination thereof), premises repairs, management, rent, taxes, office supplies, sales & marketing, board fees, audit fees, legal fees, consultant fees, and the like.

For many banks, employee and IT costs are the largest categories of non-interest cost. A staff member is an individual either on a contract or a non-contract basis including staff employed by a line of business and support department staff. A system refers to automatic processing of banking activities including network, server, banking applications and computer used by bank staff. Many banks use a Profit and Loss statement to manage and assess their non-interest costs. This has significant limitations as the focus is on profits and cost control rather than profitability and cost reduction. The Profit and Loss statement also does not provide any information on the fixed cost base of the bank or a break-up of operating costs by cost centres such as Governance Risk & Compliance, Legal, Finance, Operations, Human Capital, and Enterprise I.T. These are support departments and provide service for lines of business such as, for example, Retail Banking, Corporate Banking, and Treasury.

A conventional method for allocating or assessing costs uses a cost allocation methodology which allocates the Profit and Loss costs fully to the lines of business.

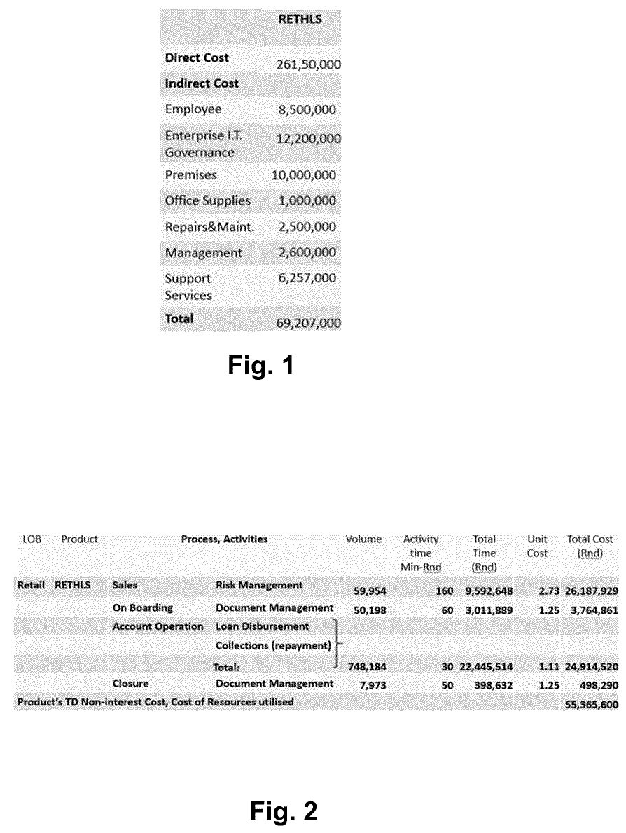

FIG. 1 illustrates one example of a particular financial product cost of a bank. It illustrates one example of the present non-interest cost allocation and management approach. This conventional allocation can be referred to as the “as is” non-interest cost management environment. This type of allocation fully charges out the incurred cost to the lines of business and does not measure resource utilization and is weak in managing a chart of cost accounts related to enterprise data for enterprise non-interest cost management

FIG. 2 illustrates time-driven activity-based cost allocation of non-interest costs for the same financial product as in FIG. 1. This assessment identifies resources (e.g., staff, systems, or other resources) used for the process and determines the actual cost for performance of the process based on resource utilization. Activity cost is derived from the cost of the resources utilized. The process cost is the sum of the cost of its activities. The time-driven activity-based non-interest cost of a product is the sum of all time-driven activity-based costs of all its processes. The time-driven activity-based non-interest cost of a line of business is the sum of all time-driven activity-based cost of its products.

In at least some embodiments, the methods and systems described herein can be used by a bank to utilize one or more of an enterprise operating model, enterprise non-interest cost management, enterprise risk-adjusted return management, or the like or any combination thereof. In at least some embodiments, the methods and systems described herein can be used by a bank to measure or improve process-based, risk-and-resource-utilization-adjusted enterprise operating models. In at least some embodiments, the methods and systems described herein can be used by a bank for process modelling using performance, risk, time, and cost data. In at least some embodiments, the methods and systems described herein can be used by a bank for performance, risk, control, time, and cost monitoring at a process level. In at least some embodiments, the methods and systems described herein can be used by a bank for process-based cost allocation or assessment. In at least some embodiments, the methods and systems described herein can be used by a bank for a time-driven activity-based non-interest cost allocation or assessment. In at least some embodiments, the methods and systems described herein can be used by a bank to account for different risks including one or more (or even all) of operational, market, credit, and liquidity risks. In at least some embodiments, the methods and systems described herein can be used by a bank to determine metrics for understanding enterprise operating model efficiency and effectiveness.

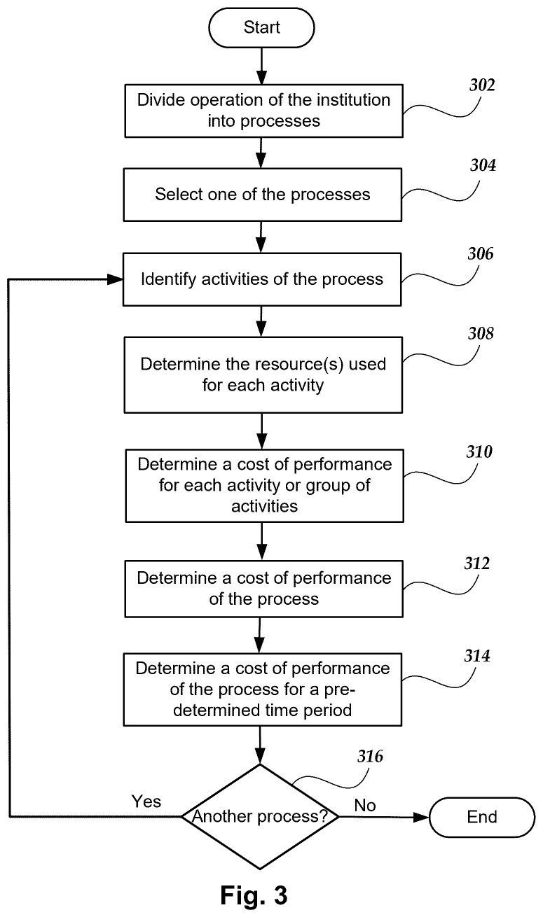

FIG. 3 is a flowchart of one embodiment of a method for assessing non-interest costs of a business process of a bank or other banking institution or non-banking finance company. In step 302, the business operation of the bank or other banking institution or non-banking finance company is decomposed into a set of processes. An inventory of processes can include both functional and technical processes. Each process can be defined or described by one or more factors including, but not limited to, purpose of the process, who performs the process, where is the process performed, who owns the process, inputs to the process, outputs of the process, a bill of resources for the process, resource consumption by the process, when the process begins/ends, whether the process is partially or fully automated or automatable, a description of individual steps of the process, or the like or any combination thereof. In at least some embodiments, the processes can be modeled using any suitable BPMS (Business Process Management Suite) technology or Hyperautomation or similar enterprise process automation or technology. Other types of software and methodologies can also be used.

In at least some embodiments, BPMS technology or similar enterprise process automation technology, can be used to capture non-interest cost data and update the book of accounts and an enterprise non-interest cost management system. In at least some embodiments, BPMS or similar enterprise process automation technology can be used, in conjunction with the methods and systems described herein, for one or more of process automation, robotic process automation, implementing and monitoring time-driven activity-based enterprise non-interest cost management, using logs for process mining and continuous process improvement, improve customer experience, improving operational risk management, or monitoring risk-adjusted performance.

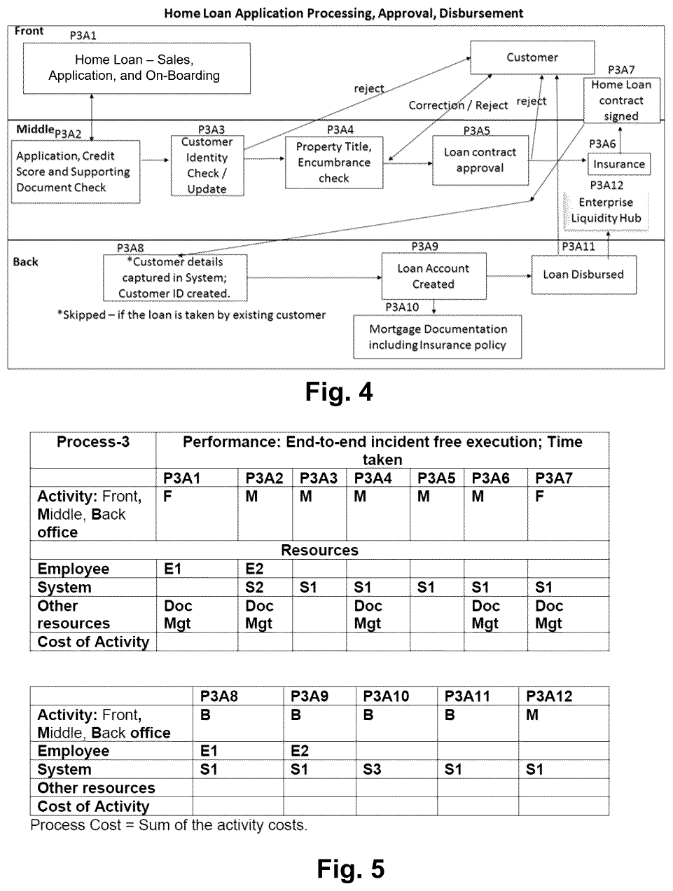

In step 304, one of the processes is selected. In step 306, that process is separated into a set of activities. FIG. 4 illustrates one example of a process for a product Home Loan for Salaried (RETHLS) that has Application Processing, Approval, and Disbursement activities P3A1 to P3A12.

In at least some embodiments, the activities are divided into Front, Middle, and Back referring to the type of process-automated business functions that are performed, as illustrated in FIG. 4. In at least some embodiments, front office functions are customer-facing processes; back office functions include accounting, settlement, reconciliation, budgeting, procurement, premises management, and reporting; and the middle office functions include, for example, risk management and compliance or the like. Any other suitable divisions (or even no divisions) can be used.

In step 308, the resources for each activity are determined using a bill of resources. In at least some embodiments, the resources can be divided into categories. FIG. 5 illustrates one example of a chart (e.g., a bill of resources) listing the resources used for each activity of the process illustrated in FIG. 4. In the chart of FIG. 4, the resources are divided into Staff (e.g., specific individuals tasked with the activity), System (which may include staff assigned to the particular system), and Other Resources (e.g., software, hardware, and other tangible assets, such as scanners, printers, or the like). Any other suitable division can be used. In the example presented in FIGS. 3 and 4, employee E1 performs activity P3A1 (“Home Loan-Sales, Application, and On-Boarding”) which also utilizes a document management resource. Employee E2 and system S2 perform activity PA3A2 (“Application, Credit Score and Supporting Document Check”) which also utilizes the document management resource. Activities P3A3-P3A9 and P3A11-P3A12 utilize system S1 and, in some cases, another resource (P3A6-P3A7—the document management resource, P3A8—employee E1, and P3A9—employee E2), and P3A10 utilizes system S3. P3A2 to P3A7 and P3A12 are risk management activities. The cost of doing business is the sum of the cost of business delivery and the cost of risk management.

In step 310, a cost for each of the activities or group of activities is determined based on the resources that were used. In at least some embodiments, two or more activities can be combined in a group for cost determination. In at least some embodiments, the cost is for one performance of the process. In the example of FIGS. 3 and 4, the cost of the process (or group of activities) is the cost for processing one home-loan application.

In at least some embodiments, the cost of the activity (or group of activities) can be determined by determining or assigning a cost per unit time for each of the resources (for example, a cost per minute or hour for the resource) and a number of time units that the activity takes to perform. The number of time units may be determined using actual data of activity performance or estimations of expected time for performance of the activity, or the like or any combination thereof. In at least some embodiments, actual time of an activity can be obtained from a process log. In at least some embodiments, the unit cost for the resources can include the cost of premises utilized and the unit cost of the support department's staff, system and other tangible assets utilized. In at least some embodiments, the number of time units can vary between the resources.

As an example, the cost for activity P3A1 is the sum of a) the product of the cost/unit time for employee E1 and the number of time units that employee E1 uses, or is expected to use, to perform activity P3A1 and b) the product of the cost/unit time for the document management resource and the number of time units that the document management resource is used, or is expected to be used, to perform activity P3A1. In at least some embodiments in which the number of time units is the same for all of the resources used to perform the activity, the cost of the activity is the sum of the costs/unit time of all of the resources and that sum is then multiplied by the number of time units.

In step 312, the time-driven cost for performance of the process is determined by summing of the costs for performance of the activities (or group(s) of activities). Optionally, in step 314, a time-driven cost for performance of the process over a pre-determined time period is determined by multiplying the time-driven cost for performance of the process one time, as determined in step 312, by N, where N is the number of times the process was performed. In at least some embodiments, N is an integer and equals, for example, the number of home loan applications that were processed.

In step 316, a query is made whether the cost of performance of another process is to be determined. If yes, then the process returns to step 306. Steps 306 to 316 are repeated for each process for which a time-driven cost of performance of the process is to be determined.

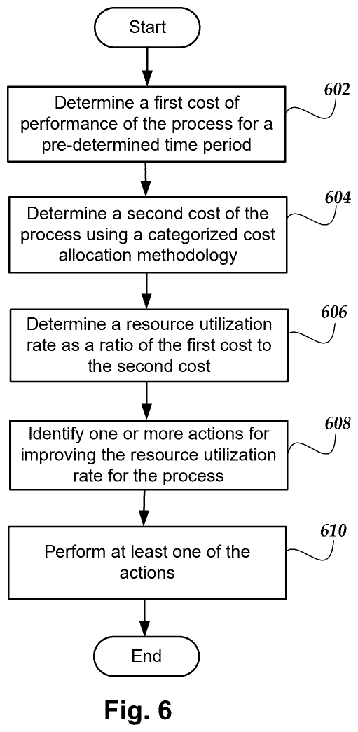

This “bill of resources” can represent activity cost and process cost. FIG. 6 illustrates one embodiment of a method for determining a resource utilization rate. In step 602, a cost of performance of the process for a pre-determined time period is determined using, for example, the method illustrated in the flowchart of FIG. 5 (e.g., a “bill of resources” or a time-driven activity-based cost allocation method). FIG. 2 illustrates one example of a time-driven cost allocation, using the “bill of resources” cost of the product, also the cost of the resources utilized for the product, is $55,365,600.

In step 604, a cost of the process is determined using a categorized cost allocation methodology (e.g., as “as-is” or Profit & Loss full cost allocation, as described above). FIG. 1 illustrates one example of a cost allocation, using the conventional categorized cost allocation methodology (e.g., the “as-is”/Profit & Loss full cost allocation), for the process of providing home loans for salaried individuals. In FIG. 1, the cost allocation for the process is $69,207,000.

In step 606, a resource utilization rate is determined as a ratio of the cost determined in step 602 to the cost determined in step 604. In at least some embodiments, a line of business resource utilization rate is calculated as:

(time-driven activity-based business cost of the line of business)/(actual cost incurred by the line of business).

In the example illustrated using FIGS. 1 and 2, the resource utilization rate is 0.8. The resource utilization rate is indicative of, or estimates, the portion of the assigned resource capacity that is actually used for the process and can indicate what portion of the resources for the process is wasted or not used to achieve the objective of the process.

The resource utilization rate can be useful for identification of, and improvement of, processes with excess resources and processes that can be made more efficient. Further analysis of the process, and the associated activities, may take into account factors, such as the skill of the staff assigned, the number of staff assigned, the quality of a system, the usage of the system as in the fluctuation of process requests (e.g., a lower level of resource utilization may be acceptable so that resources are available during periods of high process requests), wastage of floor area, alternatives such as staff working from home, video-conferencing with customers, or the like or any combination thereof.

In at least some embodiments, in step 608, the bank can use the resource utilization rate to identify one or more actions for improving the resource utilization rate for the process. For example, a lower resource utilization rate can indicate lack of skill, system weakness, idle, unneeded, or underused resources, or non-value adding activities or processes. Examples of such actions include, but are not limited to, training, system upgrade, redeploy resources that are idle or underused, eliminate or reduce unneeded or underused resources, reduce or remove activities or processes that don't add value or that have relatively low value when compared to costs, or closing unprofitable branches. In step 610, the bank can perform one or more of the actions to improve the resource utilization rate.

In at least some embodiments, a resource utilization rate for the product, a line of business, or the bank can be determined by summing the resource utilization rates of all of the products, as in FIG. 2, a line of business and then to the bank. In at least some embodiments, this composite resource utilization rate can be used to identify actions for improving the resource utilization rate and the bank, line of business, or the products. The bank can perform one or more of the actions to improve the resource utilization rate.

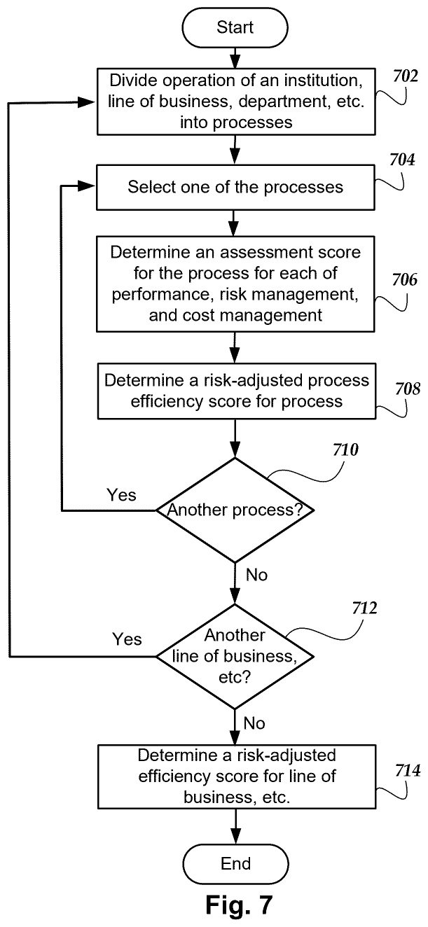

It can be useful to monitor bank operations and efficiency by incorporating a number of factors including, but not limited to, performance, risk management, and non-interest cost management. FIG. 7 is a flowchart of one embodiment of a method for determining at least one risk-adjusted performance measure of operation or operational efficiency of a bank, a line of business, a support department, a product, or a support function of the bank. In at least some embodiments, only a portion of the illustrated method is performed with only a portion of the measures or metrics being determined.

In step 702, the operation of the bank or other banking institution or non-banking finance company, a line or business, a support department, a support function, or a product of the bank is divided or decomposed into a set of individual processes, as described above with step 302 of FIG. 3. In step 704, one of the processes is selected. Examples of lines of business include, but are not limited to, retail, corporate, and treasury. Examples of support departments include, but are not limited to, human capital, I.T., governance, finance, operations, governance risk and compliance, and legal.

In step 706, an assessment score for the process for each of one or more indicators is determined. In the embodiment of FIG. 7, there are three indicators, which are performance, risk management, and cost management (e.g., non-interest cost management). In other embodiments, fewer, more, or different indicators can be used.

In at least some embodiments, the performance assessment can be made using a key performance indicator such as, for example, market share of deposits, market share of retail loans, market share of corporate loans, bank revenue, or the like. In at least some embodiments, a risk assessment can be made using one or more risk indicators. In at least some embodiments, the risk assessment can be made using a key risk indicator such as, for example, operational risks like internal fraud, external fraud, business disruption, employment and business practice, loss of data, damage to physical assets, business delivery and operational factors linked to market, credit or liquidity risks, or the like. In at least some embodiments, non-interest cost management may be assessed using the methods described above or may include comparisons of budgeted versus actual non-interest costs incurred or any combination thereof. In at least some embodiments, the assessments can be made using analytical/quantitative data, expert opinion (e.g., internal, or external opinions or any combination thereof), or any combination thereof.

In at least some embodiments, an assessment is solely a quantitative or analytical assessment or solely a qualitative assessment or any combination of quantitative/analytical and qualitative assessments. In at least some embodiments, a quantitative or analytical assessment is fully or partially made using an algorithm or artificial intelligence or other non-human assessment.

Any suitable scoring methodology can be used. As an example, one or more of the assessments can utilize a four-point (or any other suitable number of points) scoring scale.

In at least some embodiments, the top (level-4) assessment score (for example, a score of 1) is obtained by meeting a predefined goal for a predefined period of time (e.g., the assessment is stable or indicates a mature performance). Process maturity is driven by the bank's risk-adjusted performance over a “bank-defined” period, such as, for example, one, two, or three years or more. As an example, a performance assessment receives the top score when resource utilization, staff productivity, or both meet a defined goal for a defined period of time (for example, one, two, three, or four years). As another example, a risk management assessment receives the top score when measurement of residual risk, after application or risk controls and policies, is lower than a defined risk appetite for a defined period of time (for example, one, two, three, or four years). As yet another example, a non-interest cost management assessment receives the top score when non-interest costs are below a predefined goal or below budgeted non-interest costs for a defined period of time (for example, one, two, three, or four years).

In at least some embodiments, a level-3 assessment score (for example, a score of 0.8) is obtained when the defined goal is consistently achieved for less than the defined period of time but is approaching the criterion for the top score. In at least some embodiments, this evaluation can be a quantitative or analytical determination, an internal or external opinion assessment, or any combination thereof. As an example, a performance assessment receives this score when performance has been consistent for a period of evaluation (which is less than the defined period of time for the top score). As another example, a risk management assessment receives this score when there are no risk breaches during the period of evaluation. As yet another example, a non-interest cost management assessment receives this score when the non-interest costs are below the cost budget for a period of evaluation.

In at least some embodiments, a level-2 assessment score (for example, a score of 0.6) is obtained when the defined goal is achieved but there is a need or desire for improvement. In at least some embodiments, this evaluation can be a quantitative or analytical determination, an internal or external opinion, or any combination thereof. As an example, a performance assessment receives this score when performance objectives are met but improvement is needed or desired. As another example, a risk management assessment receives this score when there are only low severity breaches (e.g., breaches with actual or possible consequences below a threshold value, such as the bank's risk appetite) that are within the bank's risk appetite. As yet another example, a non-interest cost management assessment receives this score when the cost budget is exceeded, but by less than a threshold amount.

In at least some embodiments, a level-1 assessment score (for example, a score of 0.3) is obtained when the defined goal is not achieved. In at least some embodiments, this evaluation can be a quantitative or analytical determination, an internal or external opinion, or any combination thereof. As an example, a performance assessment receives this score when performance objectives are not met such as, for example, a significant fall in market share or a large number of customer complaints. As another example, a risk management assessment receives this score when there are one or more high severity breaches, for example, breaches that are above the bank's risk appetite. Other examples can include inadequacy or weakness in treasury operations, weakness in risk model maintenance, or inadequate operational support for enterprise liquidity management that leads to high severity risk incidents. As yet another example, a non-interest cost management assessment receives this score when the cost budget is exceeded beyond a threshold amount, which could indicate a weakness in resource planning.

The particular numerical values presented above are examples and can be different in other embodiments. In at least some embodiments, it is useful to have a top assessment score of 1 or to normalize the scores for use in calculations presented below. In at least some embodiments, the assessment scores can be determined for one or more of the defined processes or activities.

In step 708, a risk-adjusted process efficiency score for the process is determined. The risk-adjusted process efficiency score is determined based on a consideration of the individual assessment scores. For example, if all assessment scores for the process are level-4, indicating a mature process, the risk-adjusted process efficiency score is 1.0. If any of the assessment scores is level-1 then the risk-adjusted process efficiency score is 0.3. If all of the assessment scores are level-4 or level-3, the risk-adjusted process efficiency score is 0.8. If all of the assessment scores are level-3 or level-2, the risk-adjusted process efficiency score is 0.6. As another example, the risk-adjusted process efficiency score depends on the lowest assessment score as follows: (lowest assessment score: risk-adjusted process efficiency score) level-4:1.0, level-3:0.8, level-2:0.6, and level-1:0.3.

In step 710, a query is made whether an assessment of another process is to be performed. If yes, then the process returns to step 706. Steps 706 to 710 are repeated for each process for which an assessment is to be performed.

In step 712, a query is made whether another line of business, support department, support function, or product of the bank is to be evaluated. If yes, then the process returns to step 702. Steps 704 to 712 are repeated for each line of business, support department, support function, or product of the bank is to be evaluated.

In at least some embodiments, in step 714, a risk-adjusted operational efficiency score for a line of business, a support department, a support function, or a product of the bank can be determined by summing the risk-adjusted process efficiency scores for each process in which the line of business, the support department, the support function, or the product of the bank (or a group of processes) is involved or is responsible and then dividing by the number of processes. It is a bottom-up approach. For example, the risk adjusted operational efficiency score for the financial product of FIG. 2 is the sum of the scores of its processes. The risk adjusted operational efficiency score for Retail Banking is the sum of all risk adjusted operational efficiency score for all retail banking products. For example: Retail Banking Risk Adjusted Process Efficiency=(ΣScore*Number of processes)/Total Processes=((1*4)+(0.8*8)+(0.6*41)+ (0.3*0.7))/60=0.62.

The risk adjusted operational efficiency score for Enterprise Information Technology support department will the sum of all risk adjusted operational efficiency score for all its functions. Enterprise I.T. Governance Risk Adjusted Process Efficiency=(ΣScore*Number of processes)/Total Processes=((0.8*6)+(0.6*25)+ (0.3*15))/38=0.58.

The bank's Risk Adjusted Process based Enterprise Operating Model Efficiency=(ΣLOB or Support Risk Adjusted Process Efficiency scores) divided by nine. Nine is the sum of the three lines of business Retail, Corporate, Treasury and the six support departments-legal, operations, enterprise I.T., Finance, Human Capital, Governance Risk & Compliance departments.

In yet other embodiments, a risk-adjusted efficiency score for the bank can be determined by summing the risk-adjusted efficiency scores for all of the lines of business and support departments.

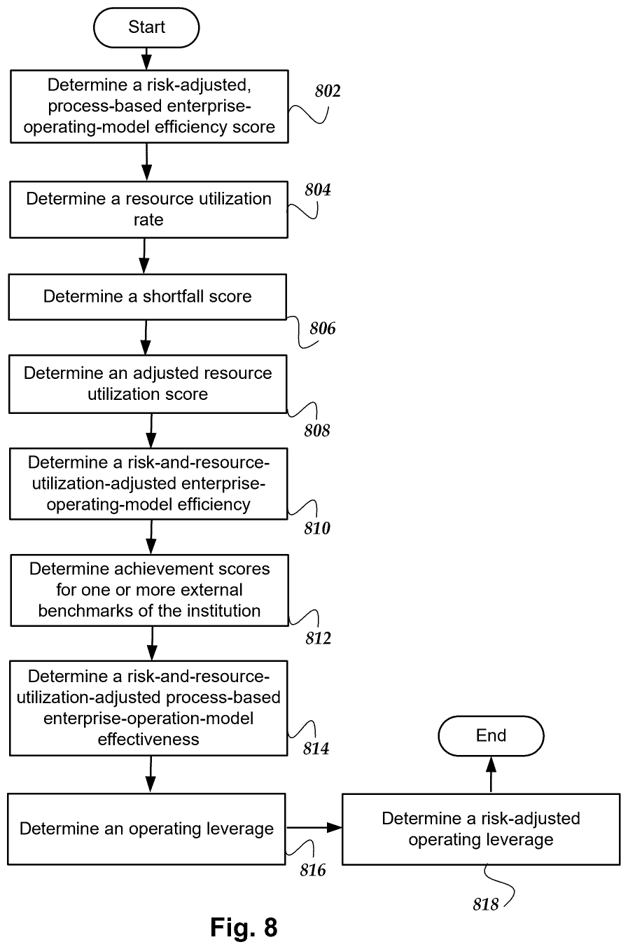

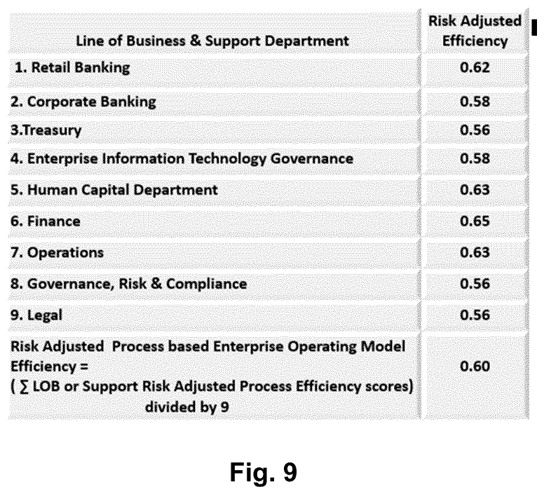

FIG. 8 is a flowchart of one embodiment of a method for determining at least one risk-adjusted performance measure of operation or risk adjusted efficiency of a bank. In step 802, the bank's risk-adjusted efficiency score, which can also be called the Risk-Adjusted, Process based Enterprise Operating Model Efficiency Score, is determined for a bank by combining the risk-adjusted efficiency scores for multiple divisions of the bank (e.g., lines of business, support departments, products, other divisions, etc.). Examples of methods for combination are presented above with respect to step 712. As an example, FIG. 9 illustrates the determination of a bank's Risk-Adjusted, Process based Enterprise Operating Model Score of 0.60 from the risk-adjusted efficiency scores for three lines of business and six support departments.

Risk Adjusted Process based Enterprise Operating Model Efficiency=(ΣLOB or Support Risk Adjusted Process Efficiency scores)divided by 9

A bank can use the Risk-Adjusted, Process based Enterprise Operating Model Efficiency Score to improve the operation of the bank. The bank can use these metrics to do one or more of the following: improve the structural efficiency of the enterprise operating model, improve, upgrade or implement an Omni-channel platform, improve go-to-market time, improve operational resilience, improve internal and external service level agreements, improve non-interest cost management, improve risk identification, improve risk mitigation, improve the enterprise control framework, improve preventive controls, add or improve layering of controls to minimize losses, ensure processes have legal clearance, ensure processes have compliance approval, reduce complexity of the enterprise operating model, identify specific trainings areas for staff, improve talent retention, redefine roles or responsibilities, align I.T. processes with functional processes, provide accurate data for funds transfer pricing, provide accurate data for product pricing, accurately determine service charges and fees for products or services, use process mining for process improvement, improve the maturity of the enterprise operating model, introduce robotic automation, improve enterprise risk adjusted returns, or the like or any combination thereof. The process efficiency score can be used for a risk-based approach internal control, internal audit, or external audit. The bank can use the risk-adjusted process-based enterprise operating model efficiency score to reduce operational risk, improve operational efficiency, improve customer service performance, or monitor operational resilience, or the like or any combination thereof.

In step 804, a resource utilization rate is determined for the bank. Examples of the determination of the resource utilization rate are presented above in connection with the flowchart of FIG. 3. In at least some embodiments, the resource utilization rate can be calculated for the lines of business separately and then combined to obtain a resource utilization rate for the bank. As an example, the resource utilization rates for three lines of business are determined to be: Retail:80%, Treasury:92.5%, Corporate:85%. The banks resource utilization rate is the sum divided by the number of divisions. In the example, the banks resource utilization rate is (80+92.5+85)/3=86%.

In step 806, a resource utilization shortfall score is determined. In at least some embodiments, the resource utilization shortfall score is based on meeting a defined or predefined resource utilization target. As an example of scoring, if the resource utilization target is met, the resource utilization shortfall score is 1. If the resource utilization target is not met, the resource utilization shortfall score depends on the percentage of the shortfall relative to the resource utilization target. For example, a shortfall of up to 5% has a resource utilization shortfall score of 0.90; a shortfall of 5% up to 10% has a resource utilization shortfall score of 0.85; a shortfall of 10% up to 15% has a resource utilization shortfall score of 0.80; and a shortfall of 15% or more has a resource utilization shortfall score of 0.70. Any other suitable set of scores or scoring criteria can be used.

In step 808, an adjusted resource utilization rate of the bank is determined as the product of the resource utilization rate of the bank multiplied by the resource utilization shortfall score. In at least some embodiments, the adjusted resource utilization rate can represent the possibility or probability of the bank building additional resource capacity in the near future. As an example, for a resource utilization rate of 0.86 and a shortfall score of 0.85, the adjusted resource utilization rate is 0.86×0.85=0.73.

In at least some embodiments, the adjusted resource utilization rate represents a downgrading because the bank has not used its resources efficiently. A bank can use the adjusted resource utilization rate to evaluate and improve 1) staff productivity, 2) system usage, 3) staffing levels (e.g., “right sizing”), 4) outsourcing of business areas, processes, activities, 5) floor space utilization or the like or any combination thereof.

In step 810, a Risk-and-Resource-Utilization-Adjusted, process-based Enterprise-Operating-Model Efficiency score is determined by multiplying Risk Adjusted Process based Enterprise Operating Model Efficiency Score by the adjusted resource utilization rate. Using the examples presented above the Risk and Resource Utilization-Adjusted, process-based Enterprise-Operating-Model Efficiency score=0.60×0.73=0.44.

A bank can use the Risk and Resource Utilization-Adjusted, process-based Enterprise-Operating-Model Efficiency score to improve the operation of the bank. The Risk and Resource Utilization-Adjusted, process-based Enterprise-Operating-Model Efficiency score reflects the performance of the in terms of key performance indicators, key risk indicators, control, costs and resource utilization. A bank can use the Risk and Resource Utilization-Adjusted, process based Enterprise-Operating-Model Efficiency score to evaluate or improve 1) the management of the bank's fixed cost base 2) internal or external Service Level Agreements 3) operational resilience, 4) enterprise operating model structural efficiency including predictable non-interest cost behaviour, 5) monitor return-on-investment for technology assets, 6) sustainable risk-adjusted operational performance, 7) staff retention 8) enterprise risk-adjusted return management, or the like or any combination thereof.

In step 812, achievement scores for one or more external benchmarks of the bank are determined. In at least some embodiments, the bank determines a target for each of the benchmarks. Examples of such benchmarks include, but are not limited to, customer experience rating, market share of deposits, market share of retail credit, and market share of corporate credit. A bank can consider all of these benchmarks or only subset of the benchmarks.

In at least some embodiments, similar to the scoring of the resource utilization shortfall, the achievement score for achieving the target for a particular benchmark can be determined based on the shortfall in achieving the target. In at least some embodiments, an achievement score is determined for each business benchmark with, for example, a score of 1 representing achievement of the target for the benchmark and scores below 1 representing a shortfall in meeting the target for the benchmark using, for example, the same scale as presented above for resource utilization shortfall. As an example, the following achievement scores are determined for achieving the targets for the respective business benchmarks: Customer Experience: 0.80; Market Share of Deposits: 0.95; Market Share of Retail Credit: 0.95; and Market Share of Corporate Credit: 1.

In step 814, Risk and Resource Utilization-Adjusted, process-based Enterprise-Operating-Model Effectiveness score is determined by multiplying the Risk and Resource Utilization-Adjusted, process-based Enterprise-Operating-Model Efficiency by each of the business benchmark scores. Using the examples presented above, the Risk and Resource Utilization-Adjusted, process-based Enterprise-Operating-Model Effectiveness=0.44×0.80×0.95×0.95×1=0.32.

A bank can use the Risk and Resource Utilization-Adjusted, process-based Enterprise-Operating-Model Effectiveness score to improve its competitive positioning. For example, the bank can use the Risk and Resource Utilization-Adjusted, process-based Enterprise-Operating-Model Effectiveness score to make comparisons with competitors, to decide on economy of scale of operations, to improve market, improve customer service and retention, validate internal performance metrics, improve product pricing, improve product promotion and selling or the like or any combination thereof.

In step 816, an operating leverage is determined as the percentage change in operating cost growth subtracted from the percentage change in revenue growth. As an example, a bank has revenues of $22.3 billion in the first year and $24.9 billion in the second year and operating costs of $20.2 billion in the first year and $21.1 billion in the second year. The percentage change in revenue growth is (($24.9-22.3)/22.3)×100=11.7 and the percentage change in operating cost growth is ((21.1−20.2)/20.2)×100=4.5. The operating leverage=11.7-4.5=7.2.

In step 818, a Risk-Adjusted Operating Leverage (RAOL) is determined by multiplying the Risk and Resource Utilization-Adjusted, process-based Enterprise-Operating-Model Effectiveness score by the operating leverage. Using the examples presented above, the RAOL=0.32×7.2=2.30.

As a second example, a bank has revenues of $22.8 billion in the first year and $24.1 billion in the second year and operating costs declined from $20.2 billion in the first year to $19.8 billion in the second year. The percentage change in revenue growth is (($24.1−22.8)/22.8)×100=5.7 and the percentage change in operating cost growth is ((19.8−20.2)/19.8)×100=−2.0. The operating leverage=5.7+2.0=7.7. The RAOL=0.32×7.7=2.46.

A bank can use the forward looking, goal oriented, RAOL score to improve the operational efficiency, effectiveness of operations and operating leverage. The RAOL is a quantification of operational performance, risk, control, and costs. As enterprise operational performance is measured accurately, it can be managed in a significantly better way. The RAOL reflects sustainable growth, operational resilience and structural operational efficiency of the bank. The RAOL can be used by the bank to improve its human capital, return on technology investment, product portfolio including pricing, business network, cost base, customer base, the bank's rating, market share, brand value, or the like or any combination thereof.

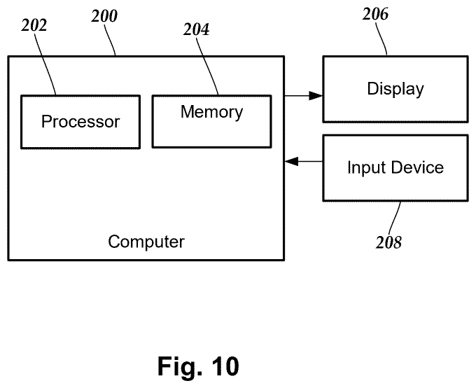

FIG. 10 illustrates one embodiment of a system for use in the methods described herein. The system can be used, for example, to perform some or all of the steps illustrated in at least FIGS. 3, 6, 7, and 8.

The system include at least one computer 200 or any other computing device that includes at least one processor 202, at least one memory 204, at least one display 206, and at least one input device 208. A computer 200 can include instructions in the memory 204 which are executed by the processor 202.

Each computer 200 can be a laptop computer, desktop computer, server computer, tablet, business process management engine, mobile device, smartphone, or other devices that can run applications or programs, or any other suitable device for processing information and for presenting a user interface. Any computer 200 can be local to the user or can include components that are non-local to the user including one or both of the processor(s) 202 or memory or memories 204 (or portions thereof). For example, in some embodiments, the user may operate a terminal that is connected to a non-local computer. In other embodiments, the memory or memories can be non-local to the user.

Each computer 200 can utilize any suitable processor 202 including one or more hardware processors that may be local to the user or non-local to the user or other components of the computer. Each processor 202 is configured to execute instructions provided to the processor.

Any suitable memory or memories 204 can be used for the computer(s) 200.

Each memory 204 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

Communication methods provide another type of computer readable media; namely communication media. Communication media typically embodies computer-readable instructions, business processes, data structures including master data such as bill of resources, risk data catalog, enterprise control catalog, enterprise non-interest cost data catalog, metadata of cost centers, profit centers, operational risk events, reference data for treasury, transactional data, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Each display 206 can be any suitable display device, such as a monitor, screen, display, or the like. Each input device 208 can be, for example, a keyboard, mouse, touch screen, track ball, joystick, voice recognition system, or any combination thereof, or the like and can be used by the user to interact with a user interface.

The methods and systems described herein may be embodied in many different forms and should not be construed as limited to the embodiments set forth herein. Accordingly, the methods and systems described herein may take the form of an entirely hardware embodiment, an entirely software embodiment or an embodiment combining software and hardware aspects. Systems referenced herein typically include memory and typically include methods for communication with other devices including mobile devices. Methods of communication can include both wired and wireless (for example, RF, optical, or infrared) communications methods and such methods provide another type of computer readable media; namely communication media. Wired communication can include communication over a twisted pair, coaxial cable, fiber optics, wave guides, or the like, or any combination thereof. Wireless communication can include RF, infrared, acoustic, near field communication, Bluetooth™, or the like, or any combination thereof.

It will be understood that each block of the flowcharts, and combinations of blocks in the flowcharts and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. The program instructions can include machine learning algorithms. Moreover, some of the steps may also be performed across more than one processor, such as might arise in a multi-processor computing device. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

The above specification provides a description of the manufacture and use of the invention. Since many embodiments of the invention can be made without departing from the spirit and scope of the invention, the invention also resides in the claims hereinafter appended.

What is claimed as new and desired to be protected is:

1. A method for assessing non-interest costs of a bank or non-banking finance company, the method comprising:
for at least one process of a bank or non-banking finance company:
identifying a plurality of activities of the process;
for each of the activities or group of activities, determining at least one staff, at least one system, at least one non-staff, non-system resource or any combination thereof that is used to perform the activity or group of activities;
for each of the activities or group of activities, determining a cost of performance of the activity or group of activities using the determined at least one staff, at least one system, at least one non-staff, non-system resource, or combination thereof that is used to perform the activity or group of activities;
determining a cost of performance of the process using the determined costs of performance of the activities and groups of activities; and
for a predefined time period in which the process is performed N times, determining a cost of the performance of the process over the predefined time period by multiplying the cost of performance by N.

2. The method of claim 1, further comprising, for at least one of the at least one process of the bank or non-banking finance company, determining a resource utilization rate for the process by dividing the time driven cost of the performance of the process over the predefined time period by the actual cost incurred for the process over the predefined time.

3. The method of claim 1, wherein determining the cost of performance of the activity comprises, for each of the at least one staff, at least one system, and at least one non-staff, non-system resource used to perform the activity, obtaining a cost per time unit.

4. The method of claim 3, further comprising, for each of the activities, obtain an number of time units for performance of the activity in a single performance of the process.

5. The method of claim 4, wherein determining the cost of performance of the activity comprises determining the cost of performing the activity by summing the costs per time unit of each of the at least one staff, at least one system, or at least one non-staff, non-system resource used to perform the activity and multiplying the sum by the number of time units used.

6. The method of claim 4, wherein determining the cost of performance of the activity comprises determining the cost of performing the activity by multiplying each of the costs per time unit of the at least one staff, at least one system, and at least one non-staff, non-system resource used to perform the activity by the number of time units used and summing results of all of the multiplications.

7. A system for assessing non-interest costs of a bank or non-banking finance company, the system comprising:
at least one memory having instructions stored thereon; and
at least one processor configured to execute the instructions to perform actions, the actions comprising:
for at least one process of a bank or non-banking finance company,
receiving a plurality of activities of the process,
for each of the activities or group of activities, receiving at least one staff, at least one system, at least one non-staff, non-system resource or any combination thereof that is used to perform the activity or group of activities,
for each of the activities or group of activities, determining a cost of performance of the activity or group of activities using the determined at least one staff, at least one system, at least one non-staff, non-system resource, or combination thereof that is used to perform the activity or group of activities,
determining a cost of performance of the process using the determined costs of performance of the activities and groups of activities, and
for a predefined time period in which the process is performed N times, determining a cost of the performance of the process over the predefined time period by multiplying the cost of performance by N.

8. A non-transitory computer readable medium having instructions stored thereon, wherein the instructions, when executed by at least one processor, are configured to perform actions for assessing non-interest costs of a bank or non-banking finance company, the actions comprising the method of claim 1.

9. A method for determining at least one risk-adjusted performance measure of operation or efficiency of a bank or non-banking finance company, the method comprising:
for each of a plurality of processes of the bank or non-banking finance company:
determining, for the process, an assessment score for each of performance, risk management, and non-interest cost management; and
determining a risk-adjusted process efficiency score as a composite of the assessment scores.

10. The method of claim 9, further comprising dividing operation of the bank or non-banking finance company into the plurality of processes of the bank or non-banking finance company.

11. The method of claim 10, further comprising, for at least one of the processes of the bank or non-banking finance company, dividing the process into a plurality of activities.

12. The method of claim 9, further comprising
identifying at least one of the processes of the financial information for efficiency improvement using the risk-adjusted process efficiency score for the processes of the financial information;
identifying at least one action to improve the efficiency of the at least one of the processes of the bank or non-banking finance company; and
perform at least one of the at least one action resulting in improvement of the efficiency of the at least one of the processes of the bank or non-banking finance company.

13. The method of claim 9, further comprising determining a risk-adjusted process-based enterprise-operating-model efficiency score as a composite of the risk-adjusted process efficiency scores of the each of the processes of the plurality of processes of the bank or non-banking finance company.

14. The method of claim 13, further comprising
determining a resource utilization rate;
determining a shortfall score based on a difference between a target rate and the resource utilization rate;
determining an adjusted resource utilization rate as a product of the resource utilization rate and the shortfall score; and
determining a risk-and-resource-utilization-adjusted, process-based enterprise-operating-model efficiency score as a product of the risk-adjusted process-based enterprise-operating-model efficiency score and the adjusted resource utilization rate.

15. The method of claim 14, further comprising
determining an achievement score for each of at least one goal of the bank or non-banking finance company; and
determining a risk-and-resource-utilization-adjusted, process-based enterprise-operating-model effectiveness score as a product of the risk-and-resource-utilization-adjusted, process-based enterprise-operating-model efficiency score and the achievement score for each of the at least one goal.

16. The method of claim 15, further comprising
determining an operating leverage value as a percentage growth in revenue minus a percentage growth in operating cost; and
determining a risk-adjusted operating leverage as a product of the risk-and-resource-utilization-adjusted, process-based enterprise-operating-model effectiveness score and the operating leverage value.

17. A system for determining at least one risk-adjusted measure of operation or efficiency of a bank or non-banking finance company, the system comprising:
at least one memory have instructions store thereon; and
at least one processor configured to execute the instructions to perform actions, the actions comprising the method of claim 9.

18. A system for determining at least one risk-adjusted measure of operation or efficiency of a bank or non-banking finance company, the system comprising:
at least one memory having instructions stored thereon; and
at least one processor configured to execute the instructions to perform actions, the actions comprising the method of claim 16.

19. A non-transitory computer readable medium having instructions stored thereon, wherein the instructions, when executed by at least one processor, are configured to perform actions for determining at least one risk-adjusted measure of operation or efficiency of a bank or non-banking finance company, the actions comprising the method of claim 9.

20. A non-transitory computer readable medium having instructions stored thereon, wherein the instructions, when executed by at least one processor, are configured to perform actions for determining at least one risk-adjusted measure of operation or efficiency of a bank or non-banking finance company, the actions comprising the method of claim 16.
